(19) United States
(12) Patent Application Publication
(10) Pub. No.: US 2009/0285184 A1
(43) Pub. Date: Nov. 19, 2009

(54) Wireless communication system and mobile terminal

(75) Inventors: Koji Watanabe, Tokyo (JP); Tomoaki Ishifuji, Tokyo (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 12/458,817

(22) Filed: Jul. 23, 2009

Related U.S. Application Data
(63) Continuation of application No. 10/929,625, filed on Aug. 31, 2004.

(30) Foreign Application Priority Data
Oct. 1, 2003 (JP) 2003-342758

(51) Int. Cl. H04W 36/30

(52) U.S. Cl. 370/332

(57) ABSTRACT

The mobile station has a monitor for monitoring the communication qualities of plural wireless interfaces and selecting one of the wireless interfaces to communicate, and a memory for storing the correspondence between the address unique to the selected wireless interface and the network address unique to the mobile station. The mobile station notifies the gateway of the correspondence. The mobile station supplies power to a not operating wireless interface at constant intervals and during a constant time to monitor the communication quality.

### CROSS-REFERENCE TO RELATED APPLICATIONS

This application is a Continuation Application of U.S. application Ser. No. 10/929,625 filed on Aug. 31, 2004. The present application claims priority from U.S. application Ser. No. 10/929,625 filed on Aug. 31, 2004, which claims priority from Japanese application 2003-342758 filed on Oct. 1, 2003, the content of which is hereby incorporated by reference into this application.

### BACKGROUND OF THE INVENTION

The present invention relates to hand-over technology in wireless system.

The hand-over between different types of media such as between cellular phone and wireless LAN is called vertical hand-over, which is reported as in the following paper.

For example, “Dynamic Network Reconfiguration Support for Mobile Computers”, written by J. Inouye, J. Binkley and J. Watpole, Proceedings of ACM/IEEE International Conference on Mobile Computing and Networking (Mobicom '97), Budapest, September 1997 (nonpatent document 1). This document describes an example of the network in which a mobile host adaptively changes the network interface and transmission route. In an experiment using this network, it is said that when the interface is changed between wired LAN and wireless LAN, the IP (Internet Protocol) address is also changed depending on the selected interface, thus making it impossible to continue an application such as telnet. If a mobile station switches from wired LAN to wireless LAN, the mobile station disconnects the communication using an IP address for wired LAN, and reconnects by using another IP address for wireless LAN. All the applications being executed must be restarted after the reconnection.

In addition, another paper is given, for example, “A Flexible Multiplexing Mechanism for Supporting Quality of Service in Mobile Environments”, written by Marc Bechler, and Hartmut Ritter, Proceedings of the Hawaii International Conference on System Science, Maui, Hawaii, January 2001, volume 9 (nonpatent document 2). This document describes an example of the hand-over between different types of media such as wireless LAN and cellular phone by using mobile IP technology. In this example, the IP packet that an application is to transmit and receive is encapsulated within the IP packet having the IP address of a selected network device and transmitted. Since the IP address of the IP packet transmitted and received by the application is constant, the application can be continued even if the hand-over process is made.

FIG. 15 shows an example of the conventional system. A mobile station 21 exchanges a registration request/response to a home agent 190 so that the mobile station 21 can register its position in the home agent 190. The home agent 190 detects the network of the mobile station 21, and registers the address in a transfer destination table. The communication from the home agent 190 to the mobile station 21 is made by “IP tunnel” in which an IP packet is encapsulated within another IP packet. When a terminal 1 transmits an IP packet to the home address of the home agent 190, the home agent 190 encapsulates the IP packet and transmits it to the care-of-address of the mobile station 21. The care-of-address of the mobile station 21 is changed in accordance with the change of network device. However, even if the care-of-address of the mobile station 21 is changed, the packet to the home address is given to the application of the mobile station 21. FIG. 16 shows the software structure of the mobile station 21. Even if the IP address (care-of-address) of TCP/IP software 104 is changed, the mobile IP 200 gives the information to the home address to a high-order application.

### SUMMARY OF THE INVENTION

It is an objective of the invention to provide a wireless system capable of continuously operating applications before and after the wireless interfaces of a mobile station are switched for communication.

It is another objective of the invention to suppress control information from increasing due to IP encapsulation.

It is still another objective of the invention to reduce the consumption power of a mobile station having a plurality of wireless interfaces.

A wireless system according to the invention has a mobile station having a plurality of wireless interfaces, and a gateway connected to a fixed network. This mobile station has means for monitoring the communication qualities of the wireless interfaces, means for selecting any one of the wireless interfaces to communicate according to the communication qualities, and means for making the unique address of the selected wireless interface be associated with the network address of the mobile station. The unique address of the wireless interface is, for example, a MAC address, and the network address of the mobile station is, for example, an IP address. The mobile station also has means for notifying the gateway of the correspondence between the unique address of the wireless interface and the network address of the mobile station.

The mobile station according to the invention has a plurality of wireless interfaces, and means for supplying power at intervals of a constant period b of time and during a constant period a of time to any one (or ones) of the wireless interfaces that is (or are) not communicating so as to monitor the communication qualities, but for not supplying power thereto except for the monitoring time.

The gateway according to the invention has means for recording the correspondence between the unique address of a wireless interface and the network address of the mobile station according to the notice from the mobile station.

According to the invention, an application for TV conference or the like can be continued without rebooting it before and after the hand-over process. In addition, since the hand-over process can be performed without producing an IP tunnel like mobile IP, the overhead on the control information is not increased due to the encapsulation of IP packet. In addition, since IP address consumption is little, addresses can be effectively used. Also, the user can easily manage IP addresses. Moreover, the mobile station according to the invention has a plurality of wireless interfaces, and means for supplying power at intervals of a constant period b of time and during a constant period a of time to any one (or ones) of the wireless interfaces that is (or are) not communicating so as to monitor the communication qualities, but for not supplying power thereto except for the monitoring time. Therefore, the consumption power in the mobile station can be reduced.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an example of the construction of a wireless system according to the invention.

FIG. 2 is a diagram showing an example of the construction of a mobile station according to the invention.

FIG. 3 is a diagram showing an example of the software structure in the mobile station according to the invention.

FIG. 4 is a diagram showing an example of the switching process in the mobile station according to the invention.

FIG. 5 is a diagram showing an example of the construction of a gateway according to the invention.

FIG. 6 is a diagram showing an example of the exchange of signals in the system according to the invention.

FIG. 7 is a diagram showing another example of the exchange of signals in the system according to the invention.

FIG. 8 is a diagram showing another example of the construction of the system according to the invention.

FIG. 9 is a diagram showing another example of the construction of the mobile station according to the invention.

FIG. 10 is a diagram showing another example of the software structure in the mobile station according to the invention.

FIG. 11 is a diagram showing another example of the switching process in the mobile station according to the invention.

FIG. 12 is a diagram showing a still another example of the exchange of signals in the system according to the invention.

FIG. 13 is a diagram showing an example of the power control method in the mobile station according to the invention.

FIG. 14 is a diagram showing an example of the format of the switching request according to the invention.

FIG. 15 is a diagram showing an example of the construction of the conventional wireless system.

FIG. 16 is a diagram showing an example of the software structure in the conventional mobile station.

FIG. 17 is a diagram showing still another example of the software structure in the mobile station according to the invention.

### DETAILED DESCRIPTION OF THE EMBODIMENTS

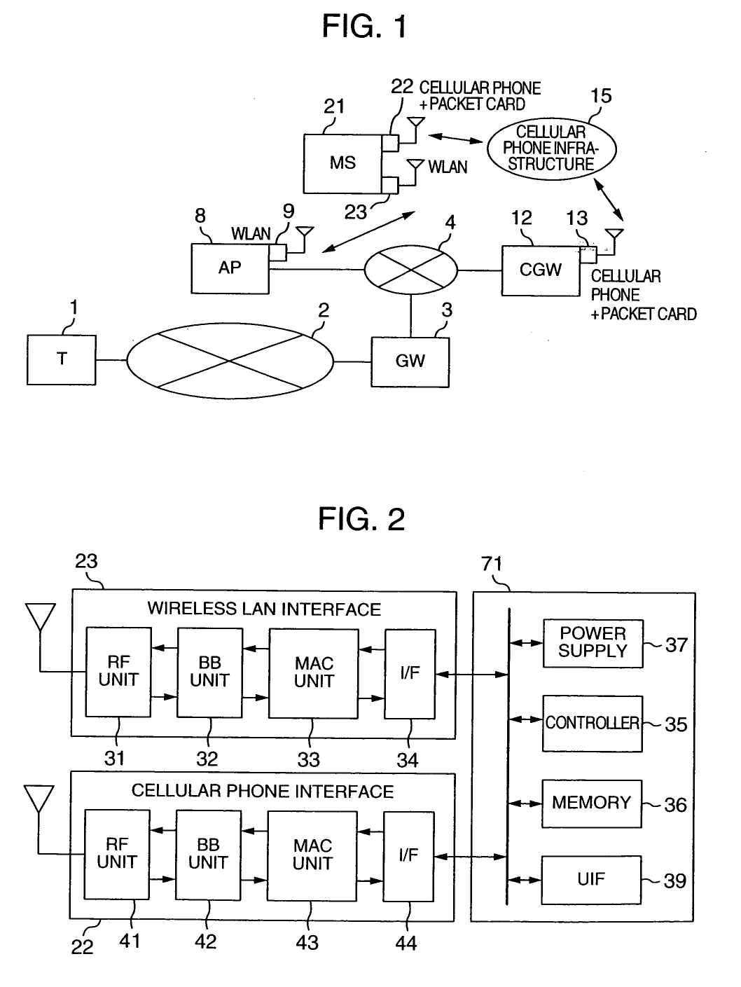

FIG. 1 shows an embodiment of a system according to the invention. The terminal 1 and a gateway (GW) 3 are connected to the public network 2. The gateway 3 receives a packet from the public network 2, and transmits it to the access point (AP) 8 or to the cellular gateway (CGW) 12. The gateway 3 also receives a packet from the access point 8 or from the cellular gateway 12 through the sub-network 4, and transmits it to the public network 2. The access point 8 has the wireless LAN interface 9 such as a wireless LAN card. The cellular gateway 12 has the cellular phone interface 13 such as a packet communication card and a cellular phone. The mobile station 21 has the wireless LAN interface 23 and the cellular phone interface 22. Communication is made between the wireless LAN interface 9 of the access point 8 and the wireless LAN interface 23 of the mobile station 21. Communication is made through a cellular phone infrastructure 15 between the cellular phone interface 13 and the cellular phone interface 22 of the mobile station 21.

FIG. 2 shows an example of the construction of the mobile station 21. An RF unit 31 or 41 receives and transmits an RF signal through an antenna, and converts the frequencies of the signals inputted from and outputted to a base band (BB) unit 32 or 42. The RF unit 31 or 41 sends the electric field intensity of the received signal to a controller 35 through the BB unit 32 or 42, a MAC unit 33 or 43, and an interface (I/F) 34 or 44. The BB unit 32 or 42 makes the assembly and modulation of wireless packets from the MAC PDU (MAC Protocol Data Unit), and supplies them to the RF unit 31 or 41. The MAC unit 33 or 43 adds a MAC header to the IP packet fed from the I/F 34 or 44 to produce the MAC PDU and supplies it to the BB unit 32 or 42. The MAC unit 33 or 43 also analyzes control information of MAC PDU fed from the BB unit 32 or 42, and processes the MAC PDU according to the MAC protocol. The MAC unit 33 or 43 receives the MAC PDU containing the IP packet from the BB unit 32 or 42 and sends the IP packet to the controller 35. The I/F 34 and I/F 44 are respectively the interfaces provided in the wireless LAN interface 23 and cellular phone interface 24 to a main body 71. These interfaces 34 and 44 play an intermediation role for the input/output information and control signal to the wireless LAN interface 23 and cellular phone interface 22, respectively. The main body 71 has a memory 36 for storing information to be transmitted and received, a power supply 37 for supplying power, a user interface 39 and the controller 35 for executing software and controlling the hardware of mobile station 21. The controller 35 is generally constructed by using a CPU that has a memory. The controller 35 monitors the communication status according to the electric field strength informed from the I/F 34 or 44 and selects the wireless interface to be switched to. In addition, the controller 35 processes the IP packet fed from the wireless LAN interface 23 or from cellular phone interface 22 according to IP (Internet Protocol). The memory 36 stores the interface to be switched to, and the controller 35 supplies IP packets to the wireless LAN interface 23 or cellular phone interface 22 according to the stored information. The main body 71 may be, for example, a laptop computer or PDA (Personal Digital Assistance). The user interface 39 is, for example, a display, loudspeaker, microphone or keyboard. The memory 36 is, for example, a memory or hard disk. It is assumed that the wireless LAN interface 23 has its own MAC address of MAC1, and that the cellular phone interface 22 has its own MAC address of MAC2. When communication starts, the mobile station 21 uses, for example, the wireless interface specified by the initial MAC address stored in the memory 36. The MAC address used before the start of communication may be held in the memory 36. In addition, the user may write MAC1 or MAC2 via the user interface in that region of memory 36 in which a MAC address is stored before the start of communication.

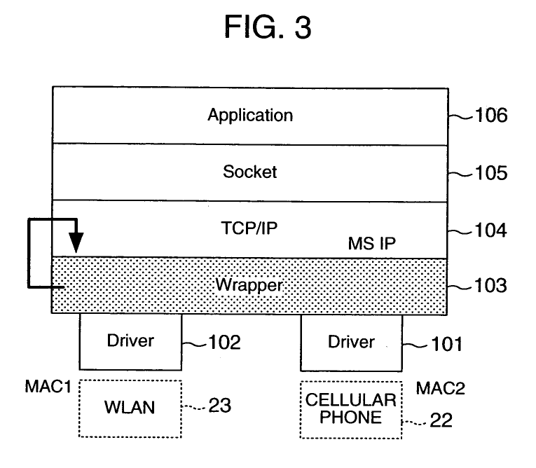

FIG. 3 shows the structure of software to be executed in the controller 35. A driver 101 is the software for controlling the cellular phone interface 22. A driver 102 is the software for controlling the wireless LAN interface 23. Wrapper is the generic name of pretreatment software for compatibility to be kept or security to be confirmed. A wrapper 103 monitors the quality of wireless communication, switches the interfaces 22, 23 according to the quality, and transmits a switching request to the gateway 3. A TCP/IP 104 is the software for making communication according to TCP (Transmission Control Protocol) and IP (Internet Protocol). The mobile station 21 is assumed to have an IP address of MS IP. A socket 105 is the TCP/IP interface used when a TCP/TP communication program is produced. An application 106 is the program for making TCP/IP communication such as telnet.

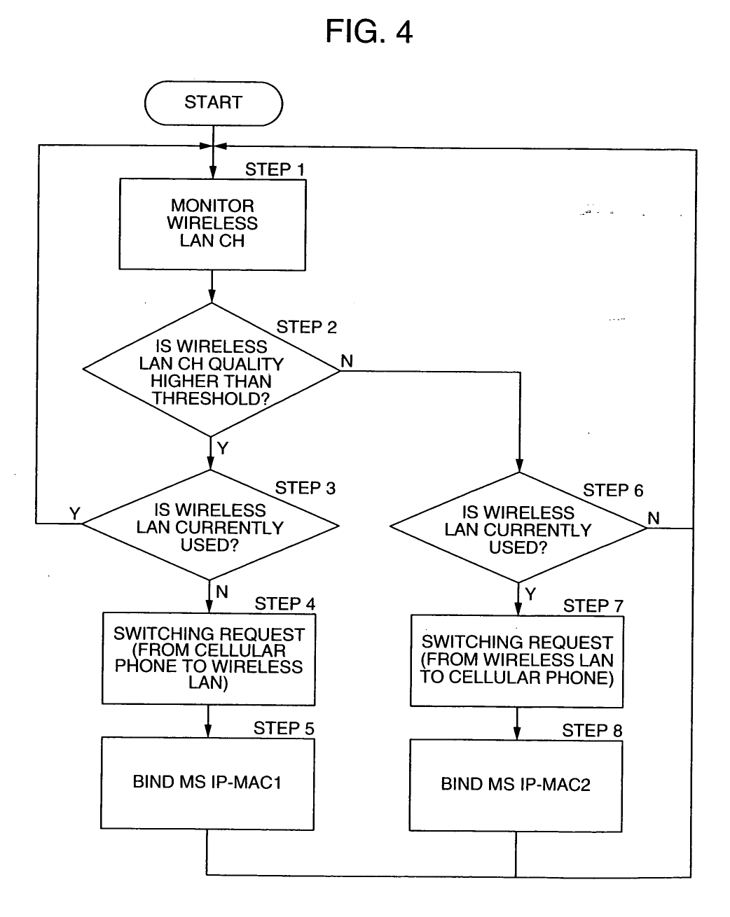

FIG. 4 shows an example of the algorithm of wrapper 103. In step 1, the communication quality of the wireless LAN is monitored, and in step 2, judgment is made of whether the current communication quality meets a criterion of switching. The communication quality may be, for example, field strength or error rate. The controller 35 monitors the field strength inputted from the I/F 34. If the field strength exceeds a threshold in step 2, judgment is made of which interface is currently used in step 3. If the current interface is not wireless LAN interface 23, a switching request is transmitted to the gateway in step 4. In step 3, the control 35 refers to the MAC address stored in the memory 36, and identifies the current interface. In step 5, the wireless LAN interface 23 is switched to, and the IP address (MS IP) is made to correspond to MAC address (MAC1). In step 5, the memory 36 stores the MAC address (MAC1) switched to. If the field strength of the wireless LAN does not exceed the threshold in step 2, judgment is made of which interface is currently used in step 6. If the current interface is the wireless LAN interface 23, a switching request is transmitted to the gateway 3 in step 7. In step 8, the cellular phone interface 22 is switched to, and the IP address (MS IP) is made to correspond to MAC address (MAC2). In step 8, the memory 36 stores the MAC address (MAC2) switched to.

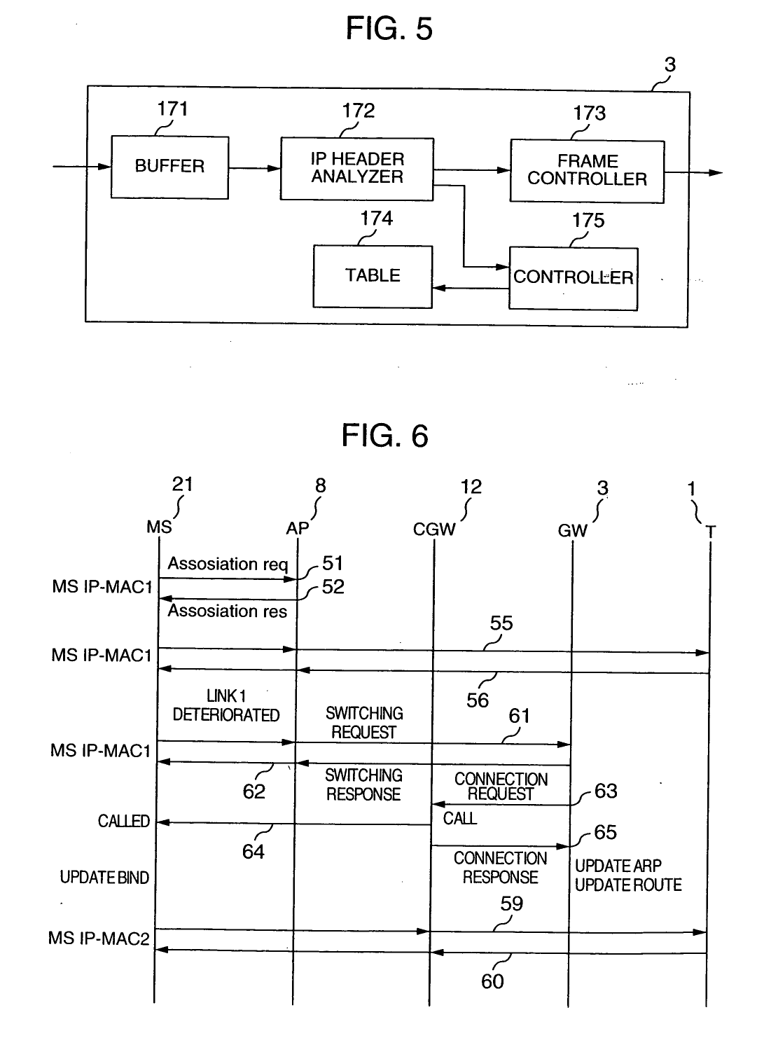

FIG. 5 shows an example of the construction of the gateway 3. When a packet is inputted to the gateway 3, it is stored in a buffer 171. A table 174 contains a routing table and an IP-MAC address correspondence table (ARP table: Address Resolution Protocol table). An IP header analyzer 172 compares the destination IP address of the header to the route information of table 174 to determine the next destination. A frame controller 173 refers to the table 174 to obtain the MAC address of the destination IP address, rewrites the MAC address of the packet inputted to the gateway 3, and transmits the packet with the address rewritten. If the packet supplied to the gateway 3 is the switching request to the gate itself (gateway 3), the controller 175 analyzes IP data 184, and rewrites the table 174 according to the information switched to that is contained in the IP data. The controller 175 searches the ARP table of the table 174 for the address specified by MS IP 186 of the switching request, and rewrites the corresponding MAC address in the table 174 into MAC address 187 specified by the switching request. After rewriting the table 174, the IP packet of the destination, MS IP 186 is transmitted to the wireless interface specified by MAC address 187 of the switching request. When the packet to the IP address of mobile station 21 is fed to the gateway 3, but when the IP address of mobile station 21 is not registered in the ARP table of table 174 due to the communication-starting time or time-out, the gateway 3 transmits an ARP request. When receiving the ARP request, the mobile station 21 refers to the MAC address of the current wireless interface stored in the memory 36, and sends the information to the gateway 3. The gateway 3 causes the information sent from the mobile station 21 to be recorded on the ARP table of table 174. After the table 174 is rewritten, the IP packet to the mobile station 21 is transmitted to the wireless interface specified by the MAC address of the current wireless interface stored in the memory 36. When the packet to the terminal 1 is supplied to the gateway 3, the gateway 3 transmits the packet according to the routing table of table 174. In addition, the controller 175 sends a switching reponse 62 to the mobile station 21, and a connection request 63 to the cellular gateway 12.

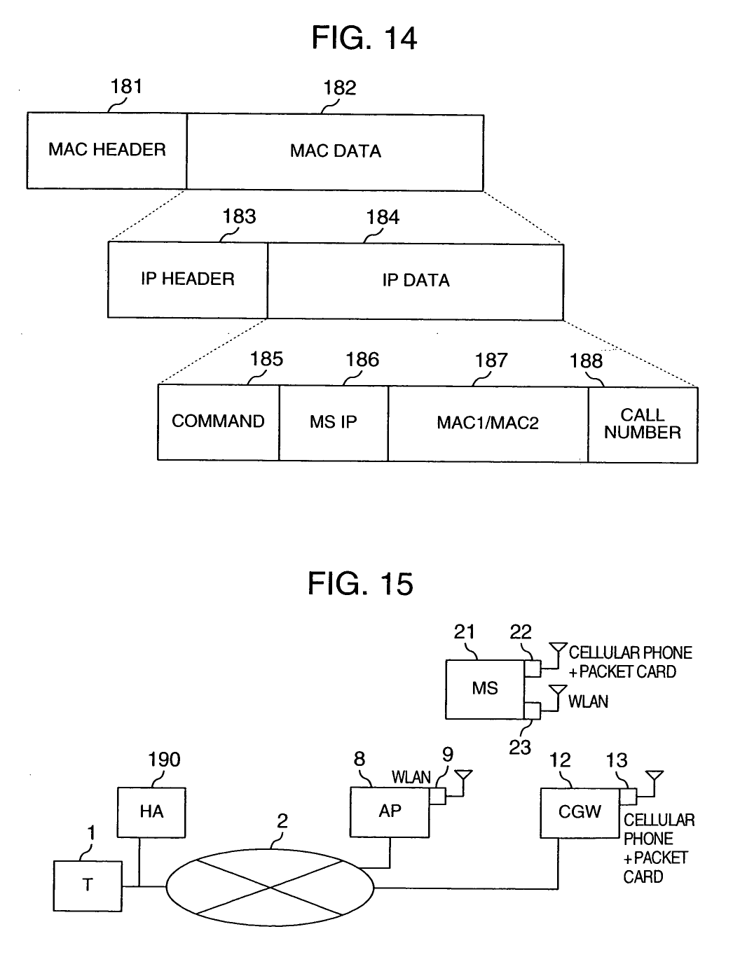

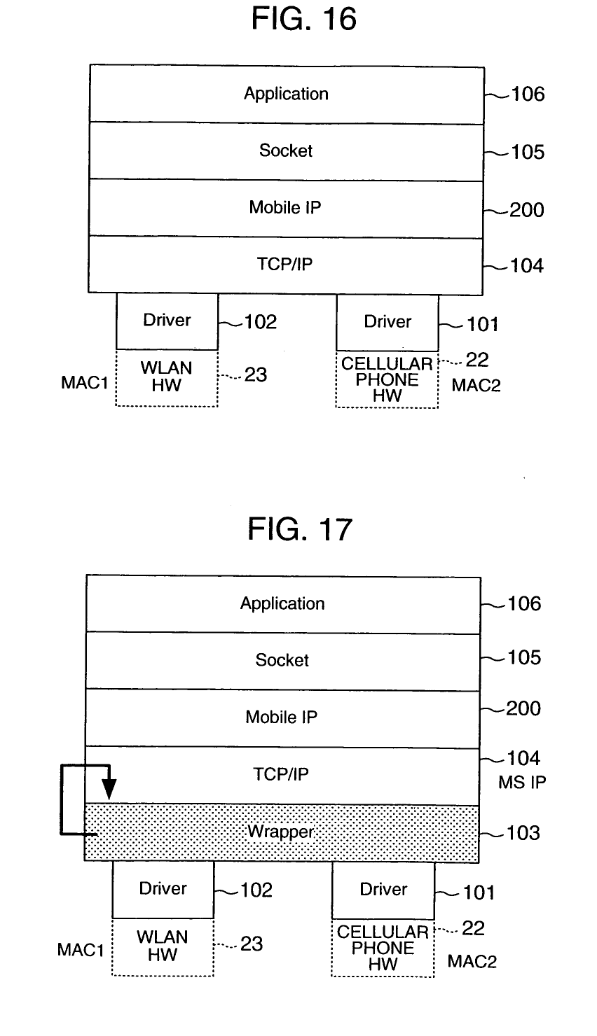

FIG. 14 shows an example of the message format of the switching request transmitted from the mobile station 21 to the gateway 3. The switching request consists of MAC header 181 and MAC data 182. The MAC data 182 contains IP header 183 and IP data 184. The IP data 184 contains a command 185 indicating the switching request, IP address 186 of mobile station 21, MAC address 187 of mobile station 21 to be switched to, and a call number 188 of mobile station 21.

FIG. 6 shows an example of the signal exchange within the system shown in FIG. 1 in the case where the mobile station 21 switches from the wireless LAN interface 23 to the cellular phone interface 22. The mobile station 21 transmits an association request 51 to the access point 8, and the access point 8 responds to this request to transmit an association response 52 to the mobile station 21, so that the mobile station 21 is associated with the access point 8. At this time, it is assumed that the MS IP and MAC1 are linked in the mobile station 21. The mobile station 21 transmits and receives packets 55, 56 via the access point 8 to and from the terminal 1 connected to the network 2. When the mobile station 21 detects that the quality of the communication between the wireless LAN interfaces 9 and 23 is deteriorated, the mobile station 21 transmits a switching request 61 to the gateway (GW) 3. The switching request 61 is transmitted so that the mobile station 21 can switch from the current one of the wireless interfaces 22 and 23 to the new one. The switching request 61 contains information of MAC address of either MAC1 or MAC2 to which the mobile station 21 is switched. In addition, when the interface to be switched to is the cellular phone interface, the switching request 61 contains the information of the telephone number of the cellular phone. The gateway 3 transmits a switching response 62 to the mobile station 21. The access point 8 may be disconnected from the mobile station 21 to stop the communication by the switching response 62. The gateway 3 transmits a connection request 63 to the cellular gateway 12. This request 63 contains the call number 188 of the cellular phone interface 22 of mobile station 21. The cellular gateway 12 calls the mobile station 21, and the mobile station 21 is called. The cellular gateway 12 transmits a connection response 65 to the gateway 3.

The gateway 3 generally knows the corre-spondence between MAC address and IP address of a host within a sub-network from the ARP (Address Resolution Protocol) before the IP communication, and manages this correspondence as ARP table. According to the ARP, the gateway 3 broadcasts an ARP request to the entire LAN, and the host, when receiving this ARP request, sends the ARP with its own MAC address written back to the gateway 3. The gateway 3 receives this MAC address, and makes communication by unicast. When the host to which the ARP request is sent does not belong to the same sub-network, the MAC address to the ARP request is treated as the MAC address of default gateway (router).

The gateway 3 refers to the information contained in the switching request 61 and changes the correspondence between MAC1 and MS IP of the ARP table to that of MAC2 and MS IP. The mobile station 21 changes the bind of MAC1 and MS IP to that of MAC2 and MS IP. The mobile station 21 transmits and receives packets 59, 60 by using the cellular phone interface 22.

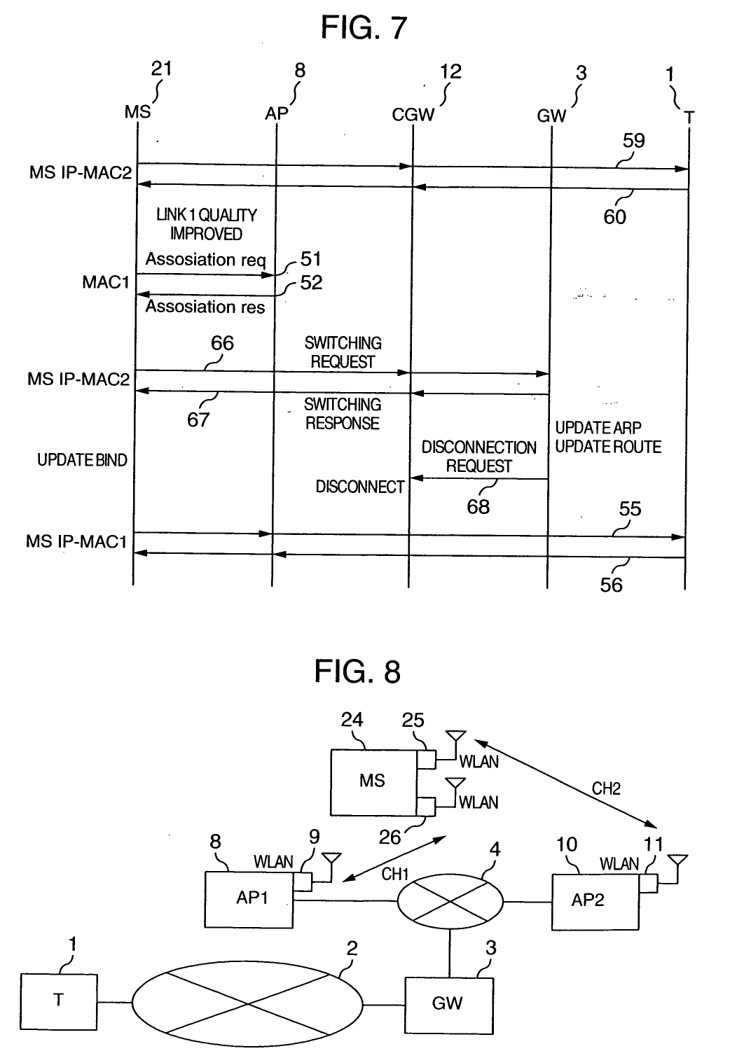

FIG. 7 shows an example of the signal exchange within the system shown in FIG. 1 in the case where the mobile station 21 switches from the cellular phone interface 22 to the wireless LAN interface 23. The mobile station 21 transmits and receives packets 59, 60 to and from the terminal 1 by using the cellular phone interface 22. At this time, it is assumed that MAC2 and MS IP are bound. In addition, it is then assumed that the mobile station 21 can assure the quality enough to communicate by wireless LAN 23 by improving the quality of communication between the wireless LAN interfaces 9 and 23. The mobile station 21 and access point 8 exchange an association request 51 and an association response 52 so that the mobile station 21 can be associated with the access point 8. The mobile station 21 transmits a switching request 66 to the gateway (GW) 3. The gateway 3 transmits a switching response 67 to the mobile station 21.

The gateway 3 refers to the information contained in the request 66 and changes the correspondence between MAC2 and MS IP of the ARP table to that of MAC1 and MS IP. The mobile station 21 changes the bind of MAC2 and MS IP to the bind of MAC1 and MS IP. The mobile station 21 transmits and receives packets 55, 56 to and from the terminal 1 by using the wireless LAN interface 23.

The cellular gateway 12 may have a dial-up router in place of the cellular phone interface 13 so that the cellular gateway 12 and cellular phone infrastructure 15 can be connected via land line network. In addition, the mobile station 21 may have more than three wireless interfaces. The cellular phone can be connected without being aware of location, but it is slow in communication speed as compared to the wireless LAN. The wireless LAN is fast in communication speed and at low cost as to the associated service fee, but the area where the service is offered is limited to dot-like areas called hotspot. If the user uses the cellular phone and wireless LAN by switching them, the service area can be expanded. Also, if the user uses the cellular phone and wireless LAN having different features by switching them, the user can acquire the merit to increase the freedom with which the user can select fast or more inexpensive service. The wireless interfaces of the mobile station 21 may be other than the combination of wireless LAN interface and cellular phone interface. For example, the mobile station 21 may have cellular phone interface and Bluetooth interface. In addition, the mobile station 21 may have, for example, cellular phone interface and UWB (Ultra WideBand) interface. The wireless interfaces of the mobile station 21 may be different types of interfaces from the wireless LAN interface. For example, the interfaces of standard IEEE 802.11a and standard 802.11b have no compatibility because the communication frequencies are different. Thus, by switching the wireless interfaces of usable standards, it is possible to expand the service area as compared with the case where an interface of a single standard is used. In an area where both standards can be used, the user can select a wireless interface of fast-communication-speed standard.

In addition, the mobile station 21 may have a plurality of interfaces of the same type. FIG. 8 shows another example of the construction of the system in the case where a mobile station 24 having wireless LAN interfaces 25, 26 makes hand-over process between the access points 8 and 10. The terminal 1 and gateway (GW) 3 are connected to the network 2. The gateway 3 routes packets to the access point 8 (AP1) or access point 10 (AP2). The access points 8 and 10 have wireless LAN interfaces 9 and 11 such as wireless LAN cards, respectively. If plural wireless LAN interfaces of the same type are provided, the status of a channel to which switching is made can be monitored in parallel by the plural wireless LAN interfaces. Also, use of plural wireless LAN interfaces of the same type will enable switching of channels such as frequencies to be fast made as compared to a mobile station having a single wireless interface. Thus, by switching wireless interfaces of the same type, it is possible to fast make hand-over processes as compared to a mobile station having a single wireless interface.

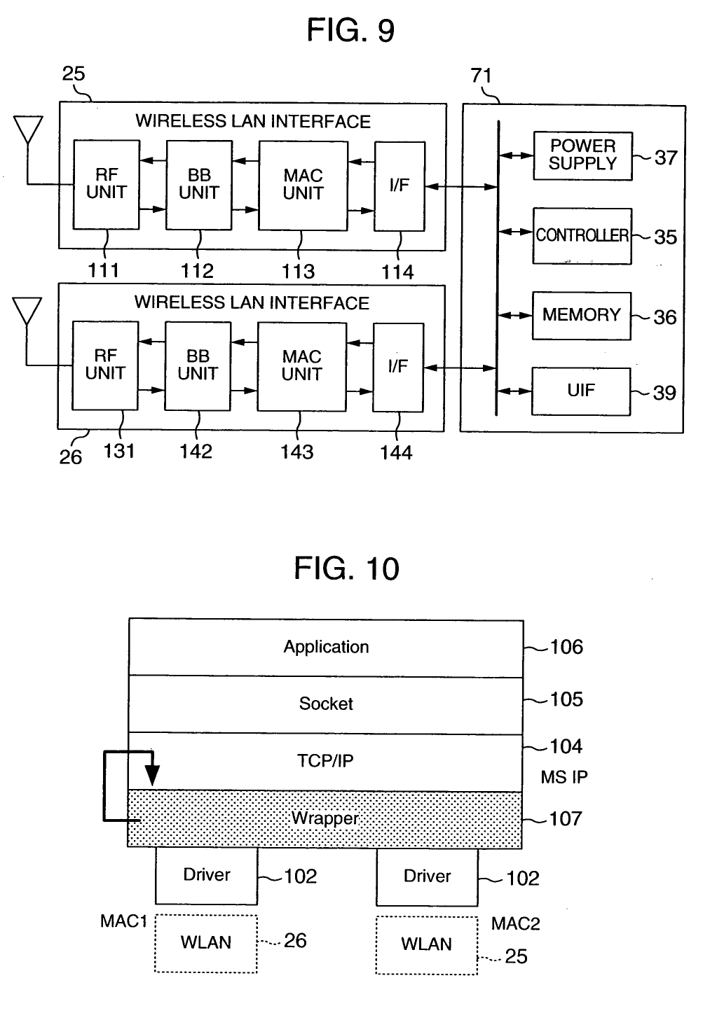

FIG. 9 shows an example of the construction of the mobile station 24. An RF unit 111 or 113 transmits and receives RF signals through an antenna, and converts the frequencies of the RF signals from and to a BB unit 112 or 142. The BB unit 112 or 142 makes the assembly and modulation of wireless packets from MAC PDU (MAC Protocol Data Unit), and supplies them to the RF unit 111 or 131. A MAC unit 113 or 143 supplies MAC PDU obtained by demodulating wireless packets to the BB unit 112 or 142, analyzes the control information of the MAC PDU fed from the BB unit 112 or 142, and processes the MAC PDU according to the MAC protocol. An I/F 114 or 144 is the interface between the wireless LAN interface 25 or 26 and the main body 71. Each I/F plays an intermediation role for the input/output information and control signal to the wireless LAN interfaces 25 and 26. The main body 71 has the memory 36 for storing the transmitted and received information, the power supply 37 for supplying electric power, the user interface 39 and the controller 35 for controlling the hardware of mobile station 24. The main body 71 may be, for example, a laptop computer. The user interface 39 is, for example, a display, loudspeaker, microphone, or keyboard. The memory 36 is, for example, a memory or hard disk.

It is assumed that the wireless LAN interfaces 26 and 25 have their own MAC addresses of MAC1 and MAC2, respectively.

FIG. 10 shows the structure of software executed by the control 35. The driver 102 is the software for controlling the wireless LAN interfaces 25 and 26. A wrapper 107 monitors the quality of wireless communication, switches the interfaces 25 and 26 according to the quality, and transmits a switching request to the gateway 3. The TCP/IP 104 is the software for making communication according to TCP (Transmission Control Protocol) and IP (Internet Protocol). The mobile station 24 is assumed to have an IP address of MS IP. The socket 105 is the TCP/IP interface used when a TCP/TP communication program is produced. The application 106 is the program for making TCP/IP communication such as telnet.

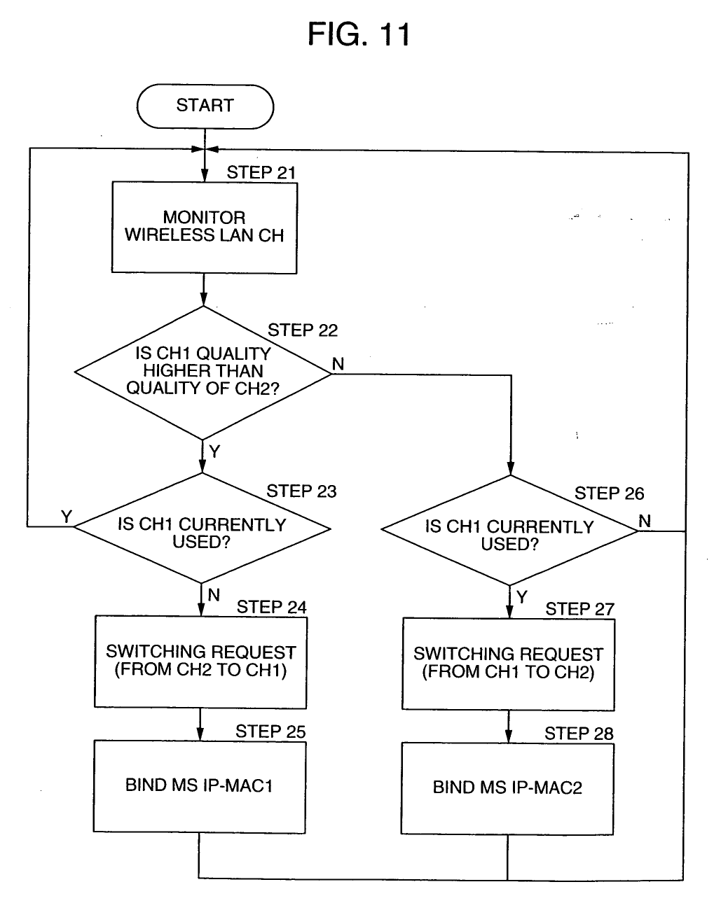

FIG. 11 shows an example of the algorithm of wrapper 107. In step 21, the communication quality of the wireless LAN 25, 26 is monitored, and in step 22 the communication quality of wireless LAN interface 25 is compared with that of wireless LAN interface 26. The communication quality may be, for example, field strength or error rate. If the wireless LAN interface 26 has a better communication quality in step 22, but is not currently used for communication, a switching request is transmitted to the gateway in step 24. In step 25, the wireless interface is switched to the wireless LAN interface 26, and the IP address (MS IP) and MAC address (MAC1) are bound together. If the wireless LAN interface 25 has better communication quality in step 22, and if the wireless LAN interface 26 is currently used to communicate, a switching request is transmitted to the gateway in step 27. In step 28, the wireless interface is switched to the wireless LAN interface 25 from the interface 26, and the IP address (MS IP) and MAC address (MAC2) are bound together.

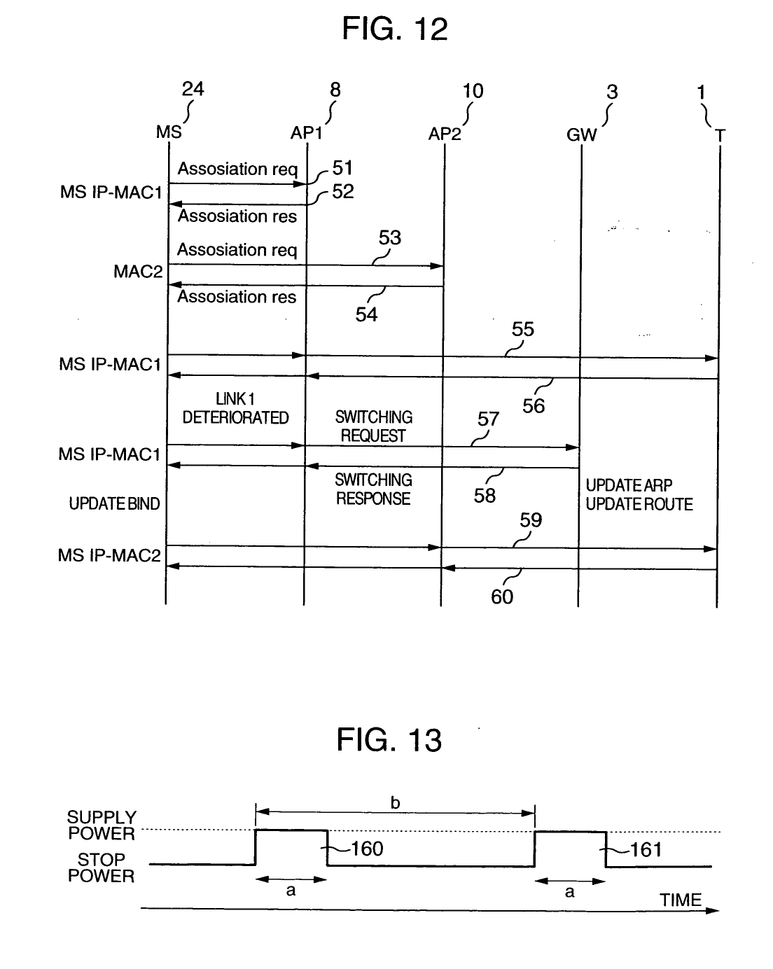

FIG. 12 shows an example of the signal exchange within the system shown in FIG. 8 in the case where the mobile station 24 switches from the wireless LAN interface 25 to the wireless LAN interface 26. It is now assumed that the mobile station 24 can assure the quality enough to communicate through wireless LAN by improving the quality of the communication between the wireless LAN interfaces 9 and 26. The mobile station 24 and the access point 8 exchange the association request 51 and the association response 52 so that the mobile station 24 can be associated with the access point 8 (AP 1). It is then assumed that the mobile station 24 can assure the quality enough to communicate through wireless LAN 25 by improving the quality of the communication between the wireless LAN interfaces 11 and 25. The mobile station 24 and access point 10 (AP 2) exchange an association request 53 and an association response 54 so that the mobile station 24 can be associated with the access point 10. The mobile station 24 transmits and receives packets 55, 56 to and from the terminal 8 by using the first associated wireless LAN interface 26. At this time, the MS IP and MAC1 are bound together in the mobile station 24.

It is assumed that the quality of communi-cation between the wireless LAN interfaces 9 and 26 is deteriorated as compared to that between the wireless LAN interfaces 11 and 25. The mobile station 24 transmits a switching request 57 to the gateway (GW) 3. The gateway 3 transmits a response 58 to the mobile station 24.

The gateway 3 refers to the information contained in the request 57 to change the corre-spondence between MAC1 and MS IP to the correspondence between MAC2 and MS IP in the ARP table. The mobile station 24 changes the bind between MAC1 and MS IP to the bind between MAC2 and MS IP. The mobile station 24 transmits and receives packets 59, 60 by using the wireless LAN interface 25.

FIG. 13 shows an example of the power control to be performed by the control 35. When the mobile station 24 starts to transmit and receive packets 59, 60 to and from the terminal 1 by using the wireless LAN interface 25, the control 35 shuts off the supply of power to stop the operation of the wireless LAN interface 26. The control 35 supplies power to the wireless LAN interface 26 during intervals 160, 161 of duration a with a period b. For example, the duration a is a few hundreds of milliseconds, and the period is a few seconds.

The mobile station generally knows the presence of a base station by receiving a beacon or probe response transmitted from the base station. A wireless LAN access point transmits a beacon at intervals of about 100 ms, and the mobile station received the beacon refers to the information contained in the beacon and registers with the base station. Alternatively, the mobile station sends a probe request and the base station catched the request transmits a probe response. The mobile station refers to the information in the probe response and registers with the base station. The wireless LAN interface 26 receives a beacon or a probe response during the intervals 160, 161, and acquires the identifiers of the surrounding base stations, and field strengths from the received signal. The controller 35 makes the processing shown in FIG. 11 by using the information obtained above.

While the above example is the case where two wireless LAN interfaces are used in the mobile station 24, the wireless mobile station 24 may have three or more wireless interfaces. In addition, the wireless interfaces may be other than the wireless LAN. Moreover, the system according to the invention may use the conventional mobile IP at the same time. In this case, a home agent is placed in the network 2. FIG. 17 shows an example of the software structure of the mobile station. IP software 200 is introduced above the TCP/IP software 104.

It should be further understood by those skilled in the art that although the foregoing description has been made on embodiments of the invention, the invention is not limited thereto and various changes and modifications may be made without departing from the spirit of the invention and the scope of the appended claims.

1. A terminal device, having a network address, connected to a public network through a gateway connected to said public network, and through first wireless communication equipment and second wireless communication equipment, said first wireless communication equipment and said second wireless communication being connected to said gateway, said terminal device comprising:
a first wireless interface having a first interface address to communicate with said first wireless communication equipment;
a second wireless interface having a second interface address to communicate with said second wireless communication equipment;
a controller to monitor at least communication quality of said first wireless interface, and select any one of said wireless interfaces for communication on a basis of said monitored communication quality; and
a memory to store a correspondence of any one of said first and second interface addresses with the network address of said terminal device,
wherein said controller associates an interface address of said selected wireless interface with said network address, stores said correspondence in said memory, and updates said correspondence in said memory if the controller selects a wireless interface which is not currently used,
said controller notifies a gateway of said correspondence via said first or second wireless communication equipment,
wherein if the communication quality of said first wireless interface does not meet a predetermined criterion during communication using said first wireless interface, said controller transmits a switching request to said gateway via said first wireless interface, receives a switching response via said first wireless interface, causes said memory to store a correspondence between said second interface address and said network address, and starts communication using said second wireless interface, and
wherein if the communication quality of said first wireless interface meets a predetermined criterion during communication using said second wireless interface, said controller transmits a switching request to said gateway via said second wireless interface, receives a switching response through said second wireless interface, causes said memory to store a correspondence between said first wireless interface address and said network address, and starts communication using said first wireless interface.

2. A terminal device according to claim 1, wherein said first wireless interface is a wireless LAN interface, and said second wireless interface is a cellular phone interface for cellular communication.

3. A terminal device according to claim 1, wherein said unique addresses of said wireless interfaces are MAC (Media Access Control) addresses, and said network address is an IP (Internet Protocol) address.

4. A terminal device according to claim 1, wherein said switching request contains said second wireless interface address.

5. A terminal device according to claim 1, wherein said switching request contains said first wireless interface address.

6. A terminal device according to claim 1, wherein when said second wireless interface is being operated for communication, said controller controls supply of power to said first wireless interface at intervals of a first period of time and during a second period of time that is shorter than said first period and measurement of the quality of communication.

7. A gateway connected to first wireless communication equipment that communicates with a terminal device having a first wireless interface having a first interface address and a second wireless interface having a second interface address through said first wireless interface of the terminal device, to second wireless communication equipment that communicates with said terminal device through said second wireless interface of the terminal device, and to a public network so that said gateway can be used for the communication between said terminal device and said public network, said gateway comprising:
a memory to store an address-correspondence table of a correspondence between a network address uniquely assigned to a communication device with which the gateway can communicate via said first wireless communication equipment, said second wireless communication equipment and said public network and an interface address uniquely assigned to a communication interface of the communication device; and
a transmission controller to determine the interface address of one of said communication devices as a next destination of a received packet by using header information of said packet and information of said address-correspondence table, and to transmit said packet to said determined interface address,
wherein when receiving a switching request from said terminal device during communication through said first wireless interface of said terminal device, said gateway transmits a switching response back to said first wireless interface, makes the interface address of said second wireless interface correspond to the network address of said terminal device to update said correspondence on said address-correspondence table, and starts communication between said second wireless interface and said gateway.

8. A gateway according to claim 7, wherein said first or second wireless interface is a wireless LAN interface.

9. A gateway according to claim 7, wherein said addresses unique to said communication interfaces are MAC (Media Access Control) addresses, and said network address is an IP (Internet Protocol) address.

10. A gateway according to claim 7, wherein said switching request includes the interface address of said second wireless interface.

11. A gateway according to claim 7, wherein said switching request is transmitted on a basis of communication quality at said first or second wireless interface.

12. A communication method used in a wireless communication system having a gateway connected to a public network, a first or second wireless communication equipment connected to said gateway, and a terminal device having first and second wireless interfaces provided to communicate with said first wireless communication equipment and second wireless communication equipment, said method including the steps of:
providing a network address assigned to said terminal device, and first and second interface addresses assigned to said first and second wireless interfaces of said terminal device; and
in said gateway, storing a correspondence between said network address of said terminal device and one of said first and second interface addresses of the wireless interfaces of said terminal device on a basis of a notice received from said terminal device, and indicating which one of said first and second wireless interfaces is used for communication;
in said gateway, when the network address of a packet received from said public network is of said terminal device, transmitting said packet to said first or second interface address according to the correspondence; and
in said gateway, in response to a switching notice from said terminal device during communication, making an interface address specified in the switching notice of said wireless interface correspond to the network address of said terminal device to update said correspondence and starting communication between said wireless interface having the specified interface address and said gateway.

13. A method according to claim 12, wherein said notice is transmitted on a basis of communication quality of said first or second wireless interface measured in said terminal device.

14. A method according to claim 13, wherein said communication quality is measured at intervals of a predetermined period of time.

15. A method according to claim 12, wherein at least one of said first and second wireless interfaces is a wireless LAN interface.

16. A method according to claim 12, wherein when receiving a switching request from said terminal device under a condition that said network address and first wireless interface address of said terminal device are recorded associated with each other, said gateway updates a correspondence between said network address and said first wireless interface address to a correspondence between said network address and said second wireless interface address of said terminal device.

17. A method according to claim 16, wherein said gateway transmits a switching response to said first wireless interface in response to said switching request.

18. A method according to claim 16, wherein said switching request indicates the interface address of said second wireless interface.
